(19) United States
(12) Patent Application Publication
(10) Pub. No.: US 2019/0152479 A1
(43) Pub. Date: May 23, 2019

(54) DEVICE FOR AIDING THE DRIVING OF A VEHICLE IN AN OBLIGATORY TRANSIT ZONE

(71) Applicant: PSA AUTOMOBILES S.A., Poissy (FR)

(72) Inventor: Nicolas Desmoineaux, Courbevoie (FR)

(21) Appl. No.: 16/092,365

(22) PCT Filed: Apr. 3, 2017
(86) PCT No.: PCT/FR2017/050766

§ 371 Date: Oct. 9, 2018

(30) Foreign Application Priority Data
Apr. 13, 2016 (FR) 1653264

(51) Int. Cl. B60W 30/18; B60W 40/04; G05D 1/00; G06K 9/00

(52) U.S. Cl. CPC B60W 30/18009; B60W 40/04; G05D 2201/0213; G06K 9/00798; G05D 1/0088

(57) ABSTRACT

A device (DA) makes it possible to aid the driving of a vehicle (V) traveling on a traffic lane (VC), comprising at least one obligatory transit zone (ZP), and comprising acquisition means (MA1) suitable for acquiring data representative of the environment in front of it. This device (DA) comprises: —analysis means (MA2) designed to analyze the environment data acquired so as to detect an obligatory transit zone (ZP) in front of the vehicle (V) and to determine information relating to the transit of the vehicle (V) through this detected obligatory transit zone (ZP), and—decision means (MD) configured, in case of detection of this obligatory transit zone (ZP), to check the dynamics of the vehicle (V) on the basis of the information determined, so that it passes through this obligatory transit zone (ZP) in accordance with regulations.

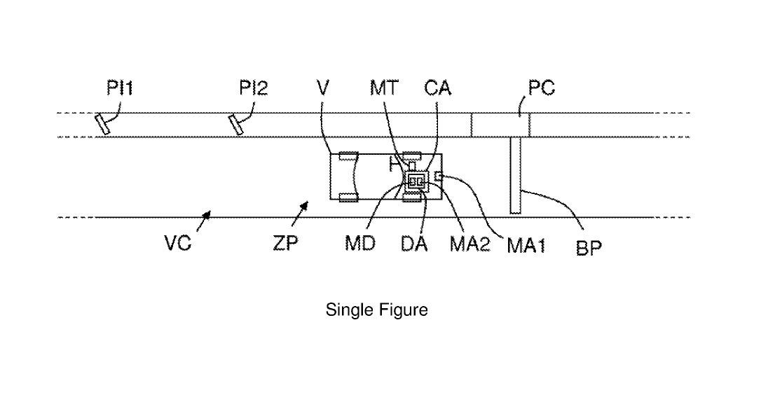

### CROSS-REFERENCE TO RELATED APPLICATIONS

This application is the US National Stage under 35 USC § 371 of International App. No. PCT/FR2017/050766 filed Apr. 3, 2017, which claims priority to French App. No. 1653264 filed Apr. 13, 2016, both of which are incorporated herein by reference.

### BACKGROUND

The invention concerns vehicles, including automobiles, and more specifically the devices that assist drivers in driving them.

As those of ordinary skill in the art know, some vehicles, generally automobiles, feature a driving aid device used to control the vehicle's position on the road laterally and to potentially drive the vehicle without the driver operating the steering wheel (in the case of autonomous driving). Such devices are capable of controlling, at least partially, the dynamics (direction, speed and acceleration) of the vehicle on the basis of information representing the vehicle's environment.

For reasons of safety, these driving aid devices must allow the driving to be shared with the driver of the vehicle, so that the driver is always able to take back at least partial control of the vehicle, in particular, to take back control of the steering wheel. This configuration is intended in particular for the management of situations not covered by the device, for example when a vehicle travels through an obligatory transit zone on a traffic lane, such as a toll. In other words, currently, when a vehicle reaches an obligatory transit zone, the driver must take back full control because the vehicle's driving aid device is not capable of managing this obligatory transit. This way of working does not therefore correspond to the expectations of an autonomously driven vehicle.

### BRIEF SUMMARY

The invention therefore aims to improve the situation.

In particular, a device, intended to assist in the driving of a vehicle traveling on a traffic lane including at least one obligatory transit zone, is provided. The device includes acquisition means able to acquire data representing the environment ahead of the vehicle.

This device includes:
analysis means configured to analyze the environment data acquired in order to detect an obligatory transit zone ahead of the vehicle and to determine information relating to this vehicle's transit through the obligatory transit zone detected, and
decision means configured, if such an obligatory transit zone is detected, to control the vehicle's dynamics on the basis of this determined information, so that the vehicle travels through this obligatory transit zone in accordance with regulations.

As such, when the vehicle reaches an obligatory transit zone, its driving aid device will continue to manage its dynamics as it travels through this obligatory transit zone, without the driver having to intervene.

The device may include other characteristics that may exist separately or in combination, in particular:
its analysis means may be configured to detect the obligatory transit zone and/or determine the information relating to the vehicle's transit through the obligatory transit zone detected on the basis of auxiliary information provided by navigational aids on board the vehicle;
the information may be selected from (at least) an obligatory transit zone, a transit lane reserved for subscribers, a speed limit through the obligatory transit zone, the presence of a lowered barrier, and ultrasound within a predefined range of frequency;
it may include acquisition means;
its decision means may be configured to stop controlling the vehicle's dynamics if the analysis means detect that a barrier has been held in a lowered position ahead of the vehicle for longer than a threshold time;
   its decision means may be configured to take back control of the vehicle's dynamics if the analysis means detect that the barrier has been raised.

In accordance with an aspect of the device, the device can include a processor which can be fitted to a vehicle featuring acquisition means able to acquire data representing the environment ahead, and featuring decision means and analysis means of the driving aid device of the type presented above.

A vehicle is also disclosed, which may be an automobile, featuring acquisition means that are able to acquire data representing the environment ahead, and a processor of the type presented above.

For example, such a vehicle may also comprise an automatic toll collection module.

### DESCRIPTION OF THE DRAWING

Other characteristics and benefits of the claimed invention will become clear from the detailed description below, and from the annexed drawing, where the single FIGURE illustrates in a schematic and functional manner a traffic lane including an obligatory transit zone in which a vehicle fitted with a driving aid device is located.

### DETAILED DESCRIPTION

A driving aid device DA is provided which is intended to assist in the driving of a vehicle V traveling on a traffic lane VC including at least one obligatory transit zone ZP.

Below, as a non-limiting example, the vehicle V is considered to be an automobile. For example, it could be a car. However, the vehicle can be any type of vehicle. The vehicle is any type of land vehicle that may move and perform maneuvers on traffic lanes including obligatory transit zones. As such, the vehicle also includes motorcycles, coaches (or buses), trucks, and utility or maintenance vehicles.

Furthermore, as a non-limiting example, the obligatory transit zone ZP is considered below to be a transit zone with a toll barrier BP that may be in a raised position allowing a vehicle to pass or a lowered position preventing the vehicle from passing. But the transit zone is not limited to this type of obligatory transit zone. Rather, the transit zone can be any type of obligatory transit zone on a traffic lane, whether or not it includes a toll barrier. As such, the transit zone can include freeways and expressways, tunnels, bridges, parking lots, entries to cities or parts of cities (for example in downtown areas) and airports. The obligatory transit zones includes both obligatory transit zones in which wireless data exchange takes place between a local control center and an automatic toll collection module (or badge) MT on board the vehicle, obligatory transit zones where the vehicle's license plate is recorded, for example using one or more cameras, without the vehicle needing to have an automatic toll collection module (or badge) MT.

The single FIGURE shows a traffic lane VC including an obligatory transit zone ZP that can be transited by a vehicle V fitted with a driving aid device DA.

As illustrated in the single FIGURE, a (driving aid) device DA features at least analysis means MA2 and decision means MD. This (driving aid) device DA may, as illustrated, be at least partially implanted in a processor CA on board a vehicle V, and possibly perform at least one other function for this vehicle (V). For example, this processor CA may be used to adapt the speed of the vehicle V to its environment at a given time (a function known as ACC (“Adaptive Cruise Control”)) or may be the on-board computer for the vehicle V. But in an alternative implementation, the device DA could include at least an on-board electronic device, for example a processor. As a result, the device DA (and in particular its analysis means MA2 and its decision means MD) may be configured in the form of logic modules (or computer modules or software), or as a combination of electronic circuits (or hardware) and software modules.

The analysis means MA2 is configured so as to analyze data representing the environment ahead of the vehicle V, acquired by acquisition means MA1 on board the vehicle V, in order to detect an obligatory transit zone ZP ahead of this vehicle V and to determine the information relating to the transit of this vehicle V through the obligatory transit zone ZP detected.

The acquisition means MA1 may, for example, comprise at least one camera and/or at least one scanning laser and/or at least one radar or lidar and/or at least one ultrasound sensor. They are used to at least analyze the environment located ahead of (or behind) the vehicle V (i.e. what is known to one of skill in the art as the “electronic horizon”). It should be noted that these acquisition means MA1 may be part of the device DA, without this being compulsory. The acquisition means could instead be part of another device on board the vehicle V and use acquired environment data to perform at least one function for this vehicle (V).

For example, the information, determined by the analysis means MA2 from environment data, may be selected from at least one type of obligatory transit zone ZP, a transit lane reserved for subscribers, a speed limit through an obligatory transit zone ZP, the presence of a lowered barrier BP, and ultrasound within a predefined range of frequencies. It should be understood that this ultrasound may, for example, indicate the presence of an obligatory transit zone or a barrier at a predefined distance.

The type of obligatory transit zone ZP may, for example, be defined by text or a symbol on a sign near the traffic lane VC, ahead of this obligatory transit zone ZP. The type of obligatory transit zone can therefore be deduced from the images acquired by the acquisition means MA1.

A transit lane reserved for subscribers may, for example, be defined using text or a symbol on a sign PI2 next to the obligatory transit zone ZP. For example, on French motorways the “t” symbol represents a special lane for automatic toll collection. This reserved transit lane can therefore be deduced from the images acquired by the acquisition means MA1.

The speed limit through an obligatory transit zone ZP may, for example, be defined by text on a sign PI1 located ahead of (or in) the obligatory transit zone ZP. This speed limit can therefore be deduced from images acquired by the acquisition means MA1.

The presence of a lowered toll barrier BP can be deduced from images acquired by the acquisition means MA1.

It should be noted that the analysis means MA2 may also be configured so as to detect the obligatory transit zone ZP and/or determine information relating to the transit of the vehicle V through this obligatory transit zone ZP, detected on the basis of auxiliary information provided by navigational aids on board the vehicle V. These navigational aids may be of the GPS type and have a map database which they use to determine part of the environment of vehicle V. This allows them to indicate the type of obligatory transit zone ZP that the vehicle V is about to travel through or the speed limit through this obligatory transit zone ZP.

The decision means MD are configured, when an obligatory transit zone ZP is detected by the analysis means MA2, so as to control the dynamics of the vehicle V on the basis of the information determined, in order for the vehicle to travel through the obligatory transit zone ZP in accordance with regulations.

The “dynamics of the vehicle V” refer here to its direction, speed and acceleration.

Furthermore, “in accordance with regulations” refers here to compliance with the local traffic code in force.

Every time that the vehicle V reaches an obligatory transit zone ZP, its device DA will detect the zone through the analysis of environment data, and will therefore continue to manage the vehicle's dynamics throughout its transit of the obligatory transit zone ZP. The device DA will therefore make the vehicle V reduce its speed to a value less than the maximum speed authorized in the obligatory transit zone ZP, so that wireless data exchange can successfully take place between the control center PC and the automatic toll collection module MT of the vehicle V (or so that the license plate of the vehicle V can be photographed) to allow any barrier BP to be raised. Then, the device DA will make the vehicle V increase its speed to a value less than the maximum speed authorized after the obligatory transit zone ZP. As such, the driver does not, in principle, need to intervene, which enables continuous autonomous driving.

It should be noted that the decision means MD may also be configured, when the analysis means MA2 detects that a barrier BP has been held in a lowered position ahead of the vehicle V for longer than a threshold time, so as to stop controlling the dynamics of the vehicle V. It should be understood that the barrier BP may be held in the lowered position as a result of a malfunction of this barrier BP and/or the associated control center PC, or a problem concerning wireless data exchange between the control center PC and the automatic toll collection module MT of the vehicle V, and solving this problem may require the intervention of the driver (calling an intercom and/or checking an automatic toll collection module MT) when the vehicle V is stopped (and therefore when the driver has taken back control of it).

For example, the threshold for the barrier BP being held in the lowered position may be between 3 seconds and 10 seconds.

It should also be noted that the decision means may also be configured, when the analysis means MA2 detects that the barrier BP has been raised, so as to take back control of the dynamics of the vehicle (V), and therefore to control the vehicle (V) out of the obligatory transit zone ZP in which it had stopped. As an alternative, the decision means MD may be configured, when the analysis means MA2 detect that the barrier BP has been raised, so as to only take back control of the dynamics of the vehicle V when the driver agrees (or requests) to do so, or once the driver has controlled his vehicle V out of the obligatory transit zone ZP in which it had stopped.

1. An autonomosuly driven vehicle comprising a driving aid device comprising acquisition means that is able operable to acquire environment data representative of an environment ahead of said vehicle, and said driving aid device further comprising i) analysis means configured so as to analyze said acquired environment data to detect an obligatory transit zone ahead of said vehicle and to determine the information relating to the transit of this vehicle through the obligatory transit zone detected, and ii) decision means configured, if said obligatory transit zone is detected, so as to control the dynamics of said vehicle on the basis of the information determined, so that said vehicle travels through said obligatory transit zone in accordance with regulations.

2. The vehicle according to claim 1, wherein said analysis means is configured so as to detect said obligatory transit zone and/or determine information relating to the transit of said vehicle through this obligatory transit zone detected on the basis of auxiliary information provided by navigational aids on board said vehicle.

3. The vehicle according to claim 1 wherein said information is selected from a group including a type of obligatory transit zone, a transit lane reserved for subscribers, a speed limit through an obligatory transit zone, the presence of a lowered barrier, and ultrasound within a predefined range of frequencies.

4. The vehicle according to claim 1, wherein said decision means is configured, if said analysis means detects that a barrier has been held in a lowered position ahead of said vehicle longer than a threshold time, so as to stop controlling said dynamics of the vehicle.

5. The vehicle according to claim 4, characterized in that said decision means is configured, if said analysis means detect that said barrier has been raised, so as to take back control of said dynamics of the vehicle.

6. The vehicle according to claim 1, wherein said vehicle comprises a processor comprising the acquisition means, the decision means and the analysis means.

7. The vehicle according to claim 1, wherein said vehicle additionally comprises an automatic toll collection module.

8. The vehicle according to claim 1 wherein said vehicle is an automobile.
